(19) United States
(12) Patent Application Publication
(10) Pub. No.: US 2011/0185402 A1
(43) Pub. Date: Jul. 28, 2011

(54) ACCESS CONTROL SYSTEM

(76) Inventors: Shaolan WANG, Beijing (CN); Hongning ZENG, Beijing (CN); Xiaoguang YU, Wuhan (CN); Hongjun YUE, Beijing (CN)

(21) Appl. No.: 12/709,893

(22) Filed: Feb. 22, 2010

(30) Foreign Application Priority Data
Jan. 26, 2010 (CN) 2010101051002

(51) Int. Cl. G06F 21/00; G06F 15/16; G06F 7/04

(52) U.S. Cl. 726/5; 709/206

(57) ABSTRACT

A key for a user can be created according to at least one first image of the user. The key can be verified with at least one second image of the user captured after the key is created. A visitor can be authenticated according to a first measure of similarity between the key and at least one authentication image of the visitor. The visitor is authenticated as the user if the first measure of similarity is greater than a first predetermined threshold. The key can be refined with the at least one authentication image of the visitor if the first measure of similarity is lower than the first predetermined threshold and the visitor is authenticated as the user based on a password.

### CROSS REFERENCE TO RELATED APPLICATION

This Application claims priority to the Chinese patent application, Application Number 2010101051002, filed on Jan. 26, 2010, which is hereby incorporated by reference.

### BACKGROUND

An access control system is a system which enables an authority to control access to areas and resources in a physical facility or computer-based information system. In operation, the access control system can authenticate a visitor who attempts to enter into the physical facility or the computer-based information system. If the access control system determines that the visitor is a registered user, the access control system can allow the visitor to enter the corresponding system.

Facial recognition technology can be used in an access control system for the authentication. The access control system can authenticate a visitor by capturing an image of the visitor and comparing the image with face templates of registered (e.g., authorized) users.

However, if the current environment in which the image of the visitor is captured is different from the previous environment in which the face template was created, e.g., the backlight in the current environment is dimmer or brighter than the backlight in the previous environment, the access control system may not authenticate the visitor correctly. Additionally, a user may make mistakes when his/her face template is created during initial registration, e.g., the wrong position or face expression may be used during registration. As such, the access control system may take a relatively long time to recognize the user during system authentication, or may be unable to recognize the user at all.

### SUMMARY

In one embodiment, a key for a user is created according to at least one first image of the user. The key is verified with at least one second image of the user captured after the key is created. A visitor is authenticated according to a first measure of similarity between the key and at least one authentication image of the visitor. The visitor is authenticated as the user if the first measure of similarity is greater than a first predetermined threshold. The key is refined with the at least one authentication image of the visitor if the first measure of similarity is lower than the first predetermined threshold and the visitor is authenticated as the user based on a password.

### BRIEF DESCRIPTION OF THE DRAWINGS

Characteristics and advantages of embodiments of the claimed subject matter will become apparent as the following detailed description proceeds, and upon reference to the drawings, wherein like numerals depict like parts, and in which:

FIG. 1 illustrates a block diagram of an access control system, in accordance with one embodiment of the present invention.

FIG. 2 illustrates a block diagram of an access control system, in accordance with one embodiment of the present invention.

FIG. 3 illustrates a flowchart of operations performed by an access control system, in accordance with one embodiment of the present invention.

FIG. 4 illustrates a flowchart of an example of a process for registering a user in an access control system, in accordance with one embodiment of the present invention.

FIG. 5 illustrates a flowchart of an example of a process for authenticating a visitor in an access control system, in accordance with one embodiment of the present invention.

FIG. 6 illustrates a flowchart of operations performed by an access control system, in accordance with one embodiment of the present invention.

### DETAILED DESCRIPTION

Reference will now be made in detail to the embodiments of the present invention. While the invention will be described in conjunction with the embodiments, it will be understood that they are not intended to limit the invention to these embodiments. On the contrary, the invention is intended to cover alternatives, modifications and equivalents, which may be included within the spirit and scope of the invention.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise, the following discussions refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

Embodiments in accordance with the present invention provide an access control system for controlling access to a system. Advantageously, the access control system can register a user, create a face template key for the user based on at least one first image (a first image set) of the user, and verify the face template key according to at least one second image (a second image set) of the user.

Furthermore, the access control system can authenticate a visitor according to a measure of similarity between the face template keys of the registered users and at least one image (an authentication image set) of the visitor, and refine a corresponding face template key according to the authentication image set of the visitor if the measure of similarity between the face template key and the authentication image set of the visitor is between a first predetermined threshold and a second predetermined threshold.

Additionally, the access control system can send at least one image (a cop image set) of the visitor to a predetermined address (e.g., a Web or email address) if the visitor is not authorized.

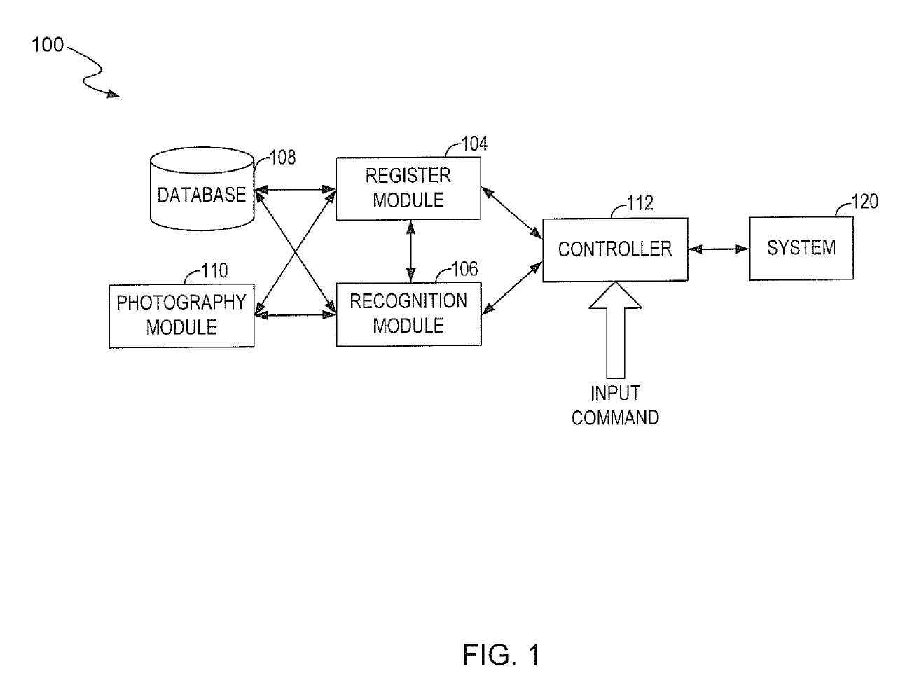

FIG. 1 illustrates a block diagram of an access control system 100 for controlling access to a system 120, in accordance with one embodiment of the present invention. The access control system 100 can create keys, e.g., face template keys, for users when the users register with the access control system, and can authenticate a visitor by comparing at least one image (an authentication image set) of the visitor with the face template keys of registered users that are stored in memory (in the following discussion, a “user” is someone who is registered with the access control system and is authorized to access the system 120, and a “visitor” is someone who is trying to access the system 120; a visitor may or may not be a user; the access control system functions to determine whether a visitor is an authorized user).

In one embodiment, the access control system 100 includes a register module 104 for registering a user and for creating a face template key for the user. At least one image (an image set) of the user can be captured by a photography module 110, e.g., a camera. The face template key can be stored in a database 108. In one embodiment, the face template key can be used to authenticate the corresponding user when the user subsequently attempts to pass through the access control system 100.

The access control system 100 further includes a recognition module 106 which is coupled to the register module 104 and is operable for authenticating a visitor by comparing at least one image (an authentication image set) of the visitor with the face template keys stored in the database 108.

Furthermore, the access control system 100 includes a controller 112 for receiving input commands, and for controlling the register module 104 and the recognition module 106 according to the input commands. The controller 112 is coupled to a physical facility or to a computer-based information system, e.g., the system 120, for controlling access to the system 120.

When a user inputs a register command to the access control system 100, the controller 112 can instruct the register module 104 to create a face template key for the user. In response to the instruction from the controller 112, the register module 104 can instruct the photography module 110 to capture at least one first image (a first image set) of the user. After receiving the first image set from the photography module 110, the register module 104 can extract characteristics of the first image set to create the face template key for the user. Techniques for creating a face template key are known in the art.

In one embodiment, after creating the face template key for the user, the register module 104 can instruct the photography module 110 to capture at least one second image (a second image set) of the user and verify the face template key based on the second image set. In one embodiment, the register module 104 can instruct the recognition module 106 to check whether the user can be authenticated based on the face template key; in other words, the second image set is used to verify that the face template key based on the first image set is satisfactory. More specifically, the register module 104 can instruct the photography module 110 to capture the second image set and send the face template key along with the second image set to the recognition module 106. Subsequently, the recognition module 106 calculates a measure of similarity S_{REG1} between the face template key and the second image set. If the measure of similarity S_{REG1} is greater than a predetermined threshold S_{PRE}, which means the recognition module 106 can recognize the user based on the face template key, the face template key can be characterized as acceptable. Otherwise, the face template key can be characterized as unacceptable and the process can be repeated until an acceptable face template key is created.

If the face template key is acceptable, the recognition module 106 can inform the register module 104 to store the face template key in the database 108. In one embodiment, the register module 104 can ask the user to input a password. The password can be stored with the face template key in the database 108. Thus, when a visitor attempts to pass through the access control system 100 and enter the system 120, the face template key can be used to authenticate the visitor. If the visitor fails to pass through the access control system 100 based on the face template key, the access control system 100 can ask the visitor to input a password and can authenticate the visitor by comparing the input password with the stored password.

In another embodiment, an acceptable face template key can be bound to log-on information (e.g., a paired username and password) for the system 120 if the system 120 includes a log-on module (e.g., a welcome module, not shown in FIG. 1). More specifically, after an acceptable face template key is created, the register module 104 can ask the user to input a username and password pair. The register module 104 can check whether the input username and password pair matches one of the pairs of usernames and passwords stored in the system 120. If the input username and password pair matches one of the stored pairs, the register module 104 can store the face template key with the matching username and password pair in the database 108 for future use. Otherwise, the register module 104 can ask the user to input another username and password. If the user inputs the username and password a predetermined number of times, e.g., three times, but each time the input username and password do not match any one of the stored pairs, the register module 104 will not store the face template key in the database 104 and rejects the user's register command.

If the face template key is unacceptable, the recognition module 106 can inform the register module 104 to create another face template key for the user.

Advantageously, after creating the face template key, the register module 104 can verify the face template key with another image (e.g., the second image set) of the user. If the measure of similarity S_{REG1} between the face template key and the second image set is greater than the predetermined threshold S_{PRE}, which means the face template key is acceptable for authenticating the corresponding user, the register module 104 can store the face template key in the database 108. Otherwise, the register module 104 will create another face template key.

When a visitor attempts to enter the system 120, the visitor inputs an access command to the access control system 100. In response to the access command, the controller 112 can direct the recognition module 106 to perform the process of authenticating the visitor.

In one embodiment, the recognition module 106 can instruct the photography module 110 to capture at least one first image (a first authentication image set) of the visitor. After receiving the first authentication image set, the recognition module 106 can fetch a face template key from the database 108 and calculate a measure of similarity S_{AUT1} between the first authentication image set and the face template key.

In one embodiment, the recognition module 106 extracts characteristics of the first authentication image set to calculate the measure of similarity S_{AUT1}. In one embodiment, if the measure of similarity S_{AUT1} is greater than a first predetermined threshold S_{PRE1}, e.g., greater than 85%, the recognition module 106 can authenticate the visitor. Thus, the visitor can enter the system 120.

In an embodiment in which the system 120 includes a log-on module that utilizes a username and password as described above, if the recognition module 106 authenticates the visitor, then the recognition module 106 can fetch the corresponding visitor's username and password pair stored with the face template key from the database 108, and send the username and password to the controller 112. The controller 112 can automatically input the username and the password into the log-on module of the system 120. As such, the visitor does not have to manually log-on to the system 120.

If the current environment in which the first authentication image set of the visitor are captured is different from the previous environments in which the face template keys were created, e.g., the backlight in the current environment is dimmer or brighter than the backlight in the previous environments, the measure of similarity S_{AUT1} may not satisfy the first predetermined threshold S_{PRE1} even if the visitor is a registered user. In one embodiment, if the measure of similarity S_{AUT1} is less than the first predetermined threshold S_{PRE1} but greater than a second predetermined threshold S_{PRE2}, e.g., between 65% and 85%, then the recognition module 106 can authenticate the visitor based on other information. In one embodiment, the recognition module 106 can ask the visitor to input a password. If the input password is stored in the database 108, the recognition module 106 can authenticate the visitor. Since the visitor can be authenticated as a registered user but the measure of similarity S_{AUT1} does not satisfy the first predetermined threshold S_{PRE1}, the current environment in which the first authentication image set is captured may be different from the previous environments in which the corresponding face template key is created. Accordingly, the recognition module 106 can refine the corresponding face template key based on the first authentication image set of the visitor. If the input password is not one of the stored passwords, the recognition module 106 can prevent the visitor from accessing the system 120.

In another embodiment in which the system 120 includes a log-on module that utilizes a username and password as described above, if the measure of similarity S_{AUT1} is between the first predetermined threshold S_{PRE1} and the second predetermined threshold S_{PRE2}, then the recognition module 106 can ask the visitor to input a username and password (instead of just a password as just described). If the input pair of username and password is one of the pairs of username and password stored in the system 120, the recognition module 106 can authenticate the visitor and refine the corresponding face template key. Otherwise, the recognition module 106 can prevent the visitor from accessing the system 120.

In yet another embodiment, if the measure of similarity S_{AUT1} is between the first predetermined threshold S_{PRE1} and the second predetermined S_{PRE2} threshold, then the recognition module 106 can instruct the photography module 110 to capture at least one second image (a second authentication image set) of the visitor. If a measure of similarity S_{AUT2} between the face template key and the second authentication image set is greater than the first predetermined threshold S_{PRE1}, the recognition module 106 can authenticate the visitor. Otherwise, the recognition module 106 will instruct the photography module 110 to capture at least one third image (a third authentication image set) of the visitor. If the photography module 110 has captured the authentication image sets (e.g., the first, second and third authentication image sets) of the visitor a predetermined number of times (e.g., three times), but each time the measure of similarity between the face template key and the corresponding authentication image set of the visitor is less than the first predetermined threshold S_{PRE1}, then the recognition module 106 can ask the visitor to input a password or a username and password pair. Subsequent operations have been described above and will not be described herein.

If the measure of similarity S_{AUT1} is less than the second predetermined threshold S_{PRE2}, the recognition module 106 can fetch another face template key from the database 108 and calculate a measure of similarity between the first authentication image set of the visitor and the other face template key.

If the measure of similarity between the first authentication image set of the visitor and each face template key in the database 108 is less than the second predetermined threshold S_{PRE2}, the recognition module 106 can determine that the visitor is not a registered user and prevents the visitor from accessing the system 120. In other embodiments, the recognition module 106 can ask the visitor to input a password or a username and password pair to authenticate the visitor.

Advantageously, the access control system 100 can refine the face template key with the image of the user captured during the authentication process (e.g., the authentication image set, or the most recent image of the user in the database 108) if the measure of similarity between the authentication image set of that user and the face template key is between the first predetermined threshold S_{PRE1} and the second predetermined threshold S_{PRE2}. As such, the user can pass through the access control system 100 relatively easily in various subsequent environments, thereby improving the performance of the access control system 100.

The controller 112 is optional and can be omitted in some embodiments. The function of the controller 112 can be integrated into the register module 104 and the recognition module 106. Thus, the register module 104 and the recognition module 106 can receive the input commands and perform the corresponding functions.

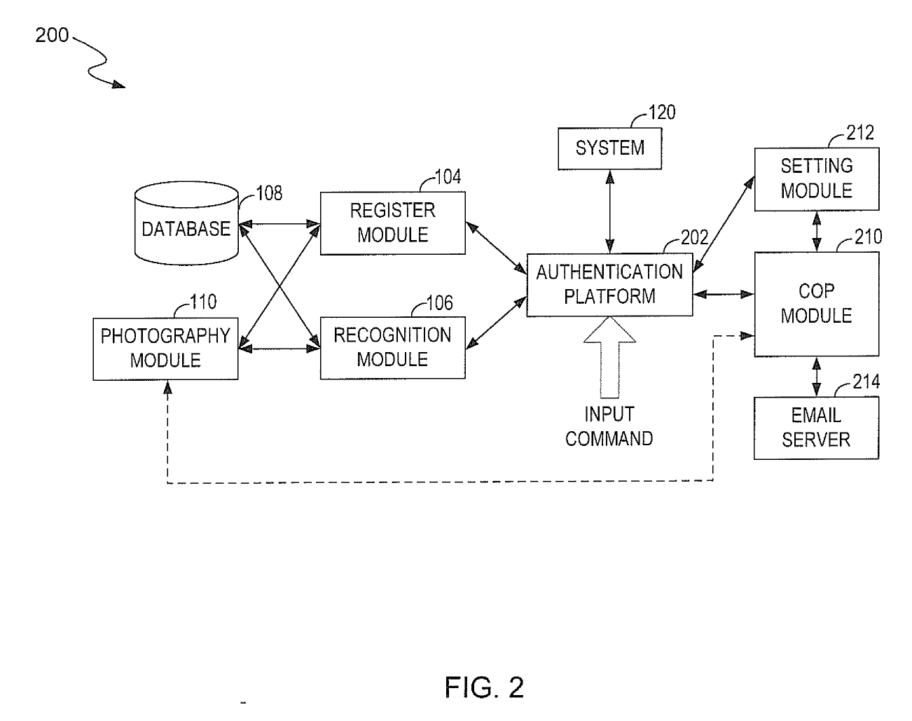

FIG. 2 illustrates a block diagram of an access control system 200 for controlling access to a system, in accordance with one embodiment of the present invention. Elements that are labeled the same as in FIG. 1 have similar functions and will not be described herein. FIG. 2 is described in combination with FIG. 1.

In one embodiment, the access control system 200 includes an authentication platform 202 for receiving input commands and for controlling the functional modules that implement corresponding functions according to the input commands. The functional modules can include, but are not limited to, the register module 104, the recognition module 106, and a cop module 210. The authentication platform 202 can control the register module 104 to register users and control the recognition module 106 to authenticate visitors. The authentication platform 202 can further control the cop module 210 to send at least one image (a cop image set) of a visitor to a predetermined address (e.g., a Web or email address) if the visitor fails to pass authentication.

In one embodiment, if the recognition module 106 determines that the visitor is not a registered user, the recognition module 106 can send a reject message to the authentication platform 202. In response to the reject message, the authentication platform 202 can instruct the cop module 210 to send at least one image (a cop image set) of the visitor to a predetermined address, e.g., an email address. In response to the instruction, the cop module 210 can instruct the photography module 110 to capture a predetermined number of images (the cop image set) of the visitor and send the cop image set to the predetermined address, in one embodiment.

In one embodiment, the predetermined number of the images can be set by a setting module 212 coupled to the cop module 210. An administrator can input a number-setting command that programs the predetermined number into the authentication platform 202. In response to the number-setting command, the authentication platform 202 can instruct the setting module 212 to program the predetermined number accordingly.

In one embodiment, the cop module 210 can send an email with the cop image set of the visitor to a predetermined email address via an email server 214. The email server 214 is coupled to the cop module 210, receives the cop image set of the visitor and the predetermined email address from the cop module 210, and sends an email including the cop image set of the visitor to the predetermined email address.

The setting module 212 can be further operable to enable and disable the cop module 210, and to set the predetermined address in the cop module 210. In one embodiment, if a user, e.g., an administrator, attempts to set or reset the predetermined address, e.g., an email address, in the cop module 210, the administrator can input an address-setting command with an address into the authentication platform 202. Subsequently, the authentication platform 202 instructs the setting module 212 to set or reset the predetermined address in the cop module 210. Additionally, the setting module 212 can program more than one input address into the cop module 210. As such, the cop module 210 can send the cop image set of the unauthorized visitor to multiple addresses.

To enable the cop module 210, an administrator can input a cop-enabling command into the authentication platform 202. Thus, the authentication platform 202 can instruct the setting module 212 to enable the cop module 210. Similarly, to disable the cop module 210, an administrator can input a cop-disabling command into the authentication platform 202. Thus, the authentication platform 202 can instruct the setting module 212 to disable the cop module 210.

Advantageously, if a person fails to pass through the access control system 200, the access control system 200 can capture at least one image (a cop image set) of the person and send the cop image set to a predetermined address. The cop image set can indicate who has tried to enter the system 120 but failed. As such, if a thief who stole a device incorporating the system 120 attempts to launch the device and enter the system 120 via the access control system 200 to use the stolen device, the unauthorized thief will fail to pass through the access control system 200. Thus the cop module 210 can send the cop image set to the device's actual owner or to a centralized service or agency acting on behalf of the actual owner. Accordingly, the received cop image set can help identify the thief.

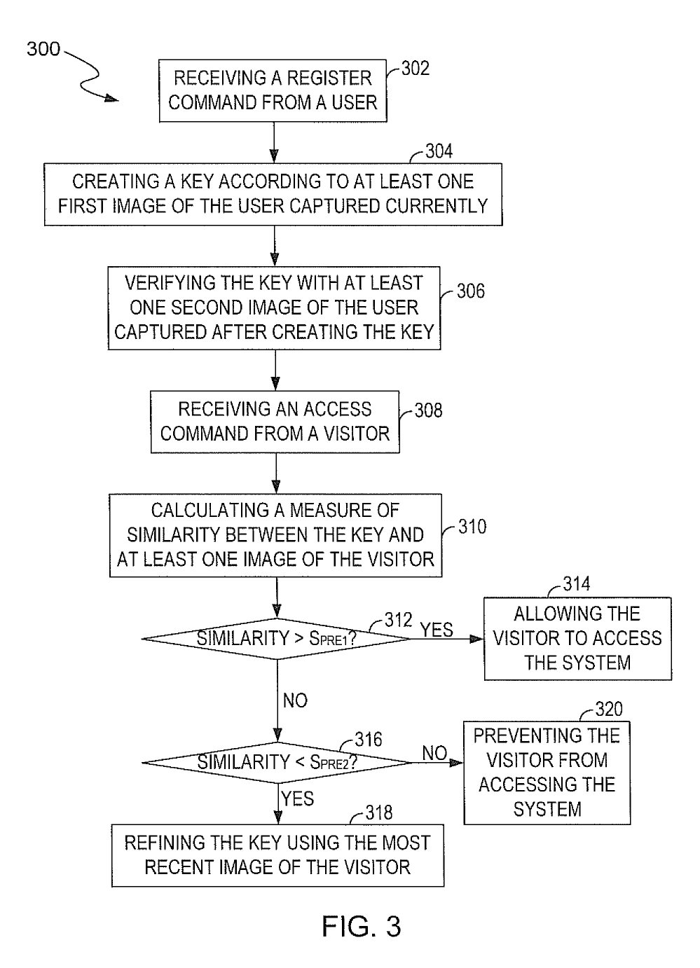

FIG. 3 illustrates a flowchart 300 of examples of operations performed by an access control system, e.g., the access control system 100 in FIG. 1, in accordance with one embodiment of the present invention. FIG. 3 is described in combination with FIG. 1.

In block 302, a user inputs a register command into the access control system 100. The controller 112 can instruct the register module 104 to register the user in response to the register command. In block 304, the register module 104 can create a key, e.g., a face template, for the user using at least one first image (a first image set) of the user captured currently. In block 306, the register module 104 can verify the eligibility of the created key with at least one second image (a second image set) of the user captured after creating the key. In one embodiment, the register module 104 can instruct the recognition module 106 to check whether the user can be authenticated correctly by comparing the created key with the second image set.

In block 308, a visitor inputs an access command into the access control system 100. The controller 112 can instruct the recognition module 106 to authenticate the visitor in response to the access command. In block 310, the recognition module 106 can calculate a measure of similarity between the key and at least one image (an authentication image set) of the visitor. More specifically, the recognition module 106 extracts characteristics of the authentication image set of the visitor to calculate the measure of similarity.

In block 312, if the measure of similarity is greater than a first predetermined threshold S_{PRE1}, the recognition module 106 can authenticate the visitor (block 314). Thus, the visitor can pass through the access control system 100 and enter the system 120. In block 316, if the measure of similarity is less than the first predetermined threshold S_{PRE1} but greater than a second predetermined threshold S_{PRE2}, the recognition module 106 can refine the key using the most recent image of the visitor (block 318). Furthermore, if the measure of similarity is less than the second predetermined threshold S_{PRE2}, the recognition module 106 can prevent the visitor from accessing the system 120 (block 320).

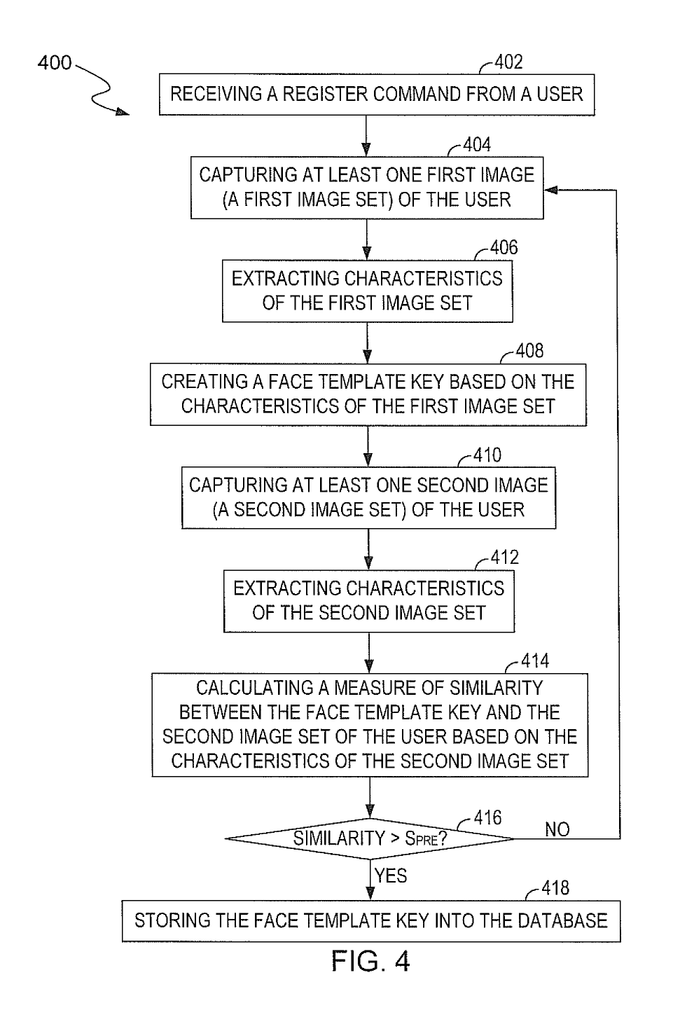

FIG. 4 illustrates a flowchart 400 of an example of a method of registering a user in an access control system, e.g., the access control system 100 in FIG. 1, in accordance with one embodiment of the present invention. FIG. 4 is described in combination with FIG. 1.

In block 402, a user inputs a register command into the access control system 100. In block 404, the register module 104 instructs the photography module 110 to capture at least one first image (a first image set) of the user. In block 406, the register module 104 extracts characteristics of the first image set. In block 408, the register module 104 creates a face template key based on the extracted characteristics of the first image set.

In block 410, the register module 104 can instruct the photography module 110 to capture at least one second image (a second image set) of the user. Then, the register module 104 sends the created face template key along with the second image set of the user to the recognition module 106. In block 412, the recognition module 104 extracts characteristics of the second image set. In block 414, the recognition module 106 calculates a measure of similarity between the created face template key and the second image set of the user based on the characteristics of the second image set.

In block 416, if the measure of similarity is greater than a predetermined threshold S_{PRE}, which means that the face template key is acceptable for the recognition module 106 to subsequently authenticate the user, the face template key can be stored in the database 108 (block 418).

In block 416, if the measure of similarity is not greater than the predetermined threshold S_{PRE}, the face template key can be classified as unacceptable. The flowchart 400 will return to block 404 to create another face template key for the user.

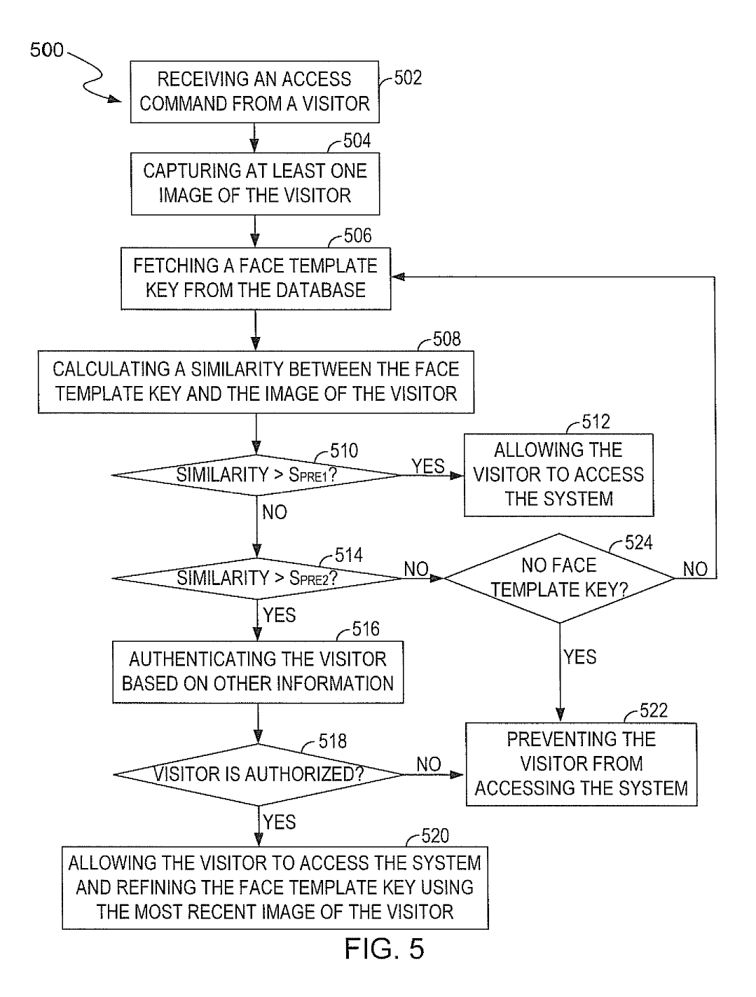

FIG. 5 illustrates a flowchart 500 of an example of a method for authenticating a visitor using an access control system, e.g., the access control system 100 in FIG. 1, in accordance with one embodiment of the present invention. FIG. 5 is described in combination with FIG. 1.

In block 502, a visitor inputs an access command into the access control system 100. In block 504, the recognition module 106 instructs the photography module 110 to capture at least one image (an authentication image set) of the visitor. In block 506, the recognition module 106 fetches a face template key from the database 108. In block 508, the recognition module 106 calculates a measure of similarity between the face template key and the authentication image set of the visitor. In block 510, if the measure of similarity is greater than a first predetermined threshold S_{PRE1}, the recognition module 106 can allow the visitor to access the system 120 (block 512).

In block 514, if the measure of similarity is less than the first predetermined threshold S_{PRE1} but greater than a second predetermined threshold S_{PRE2}, the recognition module 106 can attempt to authenticate the visitor based on other information, e.g., a password or a username and password pair. In block 518, if the visitor is authorized to pass through the access control system 100, the recognition module 106 can allow the visitor to access the system 120 and refine the face template key using the most recent image of the visitor (block 520). In block 518, if the visitor is not authenticated, the recognition module 106 can prevent the visitor from accessing the system 120 (block 522).

Returning to block 514, if the measure of similarity is less than the second predetermined threshold S_{PRE2}, then in block 524, if the authentication image set of the visitor does not match the face template keys stored in the database 108 (the measures of similarity between the face template keys and the authentication image set of the visitor are less than second predetermined threshold S_{PRE2}), the recognition module 106 can prevent the visitor from accessing the system 120 (block 522). Otherwise, the flowchart returns to block 506 and another face template key is fetched from the database 108.

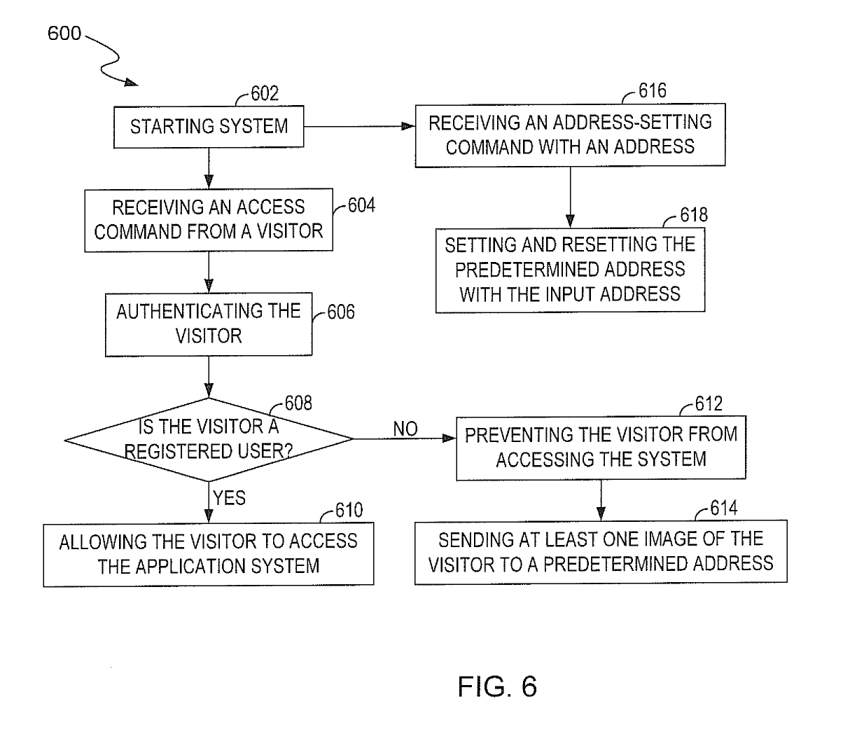

FIG. 6 illustrates a flowchart 600 of examples of operations performed by an access control system, e.g., the access control system 200 in FIG. 2, in accordance with one embodiment of the present invention. Similar steps that are described in FIG. 3, FIG. 4 and FIG. 5 will not be described herein. FIG. 6 is described in combination with FIG. 2.

In block 602, the access control system 200 starts to operate. In block 604, the access control system 200 receives an access command from a visitor. In block 606, the authentication platform 202 instructs the recognition module 106 to authenticate the visitor. If the recognition module 106 determines that the visitor is one of the registered users (block 608), the access control system 200 allows the visitor to access the system 120 (block 610). Otherwise, in block 612, the access control system 200 prevents the visitor from accessing the system 120. Furthermore, in block 614, the authentication platform 202 can instruct the cop module 210 to send at least one image (a cop image set) of the visitor to a predetermined address.

In one embodiment, the cop module 210 can instruct the photography module 110 to capture a predetermined number of images (the cop image set) of the visitor and send the cop image set of the visitor to a predetermined address (e.g., a Web or email address).

In one embodiment, the cop module 210 can send an email with the cop image set of the visitor to a predetermined email address via the email server 214. The email server 214 receives the cop image set of the visitor and the predetermined email address from the cop module 210 and sends an email including the cop image set of the visitor to the predetermined email address.

In block 616, if a user, e.g., an administrator, inputs an address-setting command with an address into the authentication platform 202, the authentication platform 202 can instruct the setting module 212 to set and reset the predetermined address of the cop module 210 with the input address (block 618). Furthermore, the setting module 212 can program more than one input address into the cop module 210.

Additionally, the setting module 212 can also enable or disable the cop module 210. If the setting module 212 disables the cop module 210, the cop module 210 will not send the cop image set of the visitor to the predetermined address if the access control system 200 determines that the visitor is not a registered user.

Accordingly, embodiments in accordance with the present invention provide an access control system for controlling access to systems. In one embodiment, the access control system creates a face template key according to at least one first image (a first image set) of a registered user captured currently. The created face template key can be verified by calculating a measure of similarity between the face template key and at least one second image (a second image set) of the registered user. If the measure of similarity is lower than a predetermined threshold, the face template key can be characterized as unacceptable and the process can be repeated until an acceptable face template key is created.

The access control system can identify whether a visitor is a registered user by calculating a measure of similarity between the face template key of the registered user and at least one image (an authentication image set) of the visitor. If the measure of similarity is greater than a first predetermined threshold, the visitor can be authenticated as the registered user. If the measure of similarity is lower than the first predetermined threshold and greater than a second predetermined threshold, the identity of the visitor can be authenticated based on other information, e.g., a password or username and password pair. If the visitor can be authenticated as the registered user based on the password or the username and password pair, the face template key can be refined using the most recent image of the visitor.

If the measure of similarity is lower than the second predetermined threshold, or the visitor input a wrong password or username and password pair, the access control system determines the visitor is not the registered user and prevents the visitor from accessing the system. Furthermore, the access control system can send at least one image (a cop image set) of the visitor to a predetermined address if the visitor is not the registered user.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A computer-readable medium having computer-executable modules comprising:
a register module operable for creating a key of a user according to at least one first image of said user, and also operable for verifying said key with at least one second image of said user captured after creating said key; and
a recognition module operable for authenticating a visitor according to a first measure of similarity between said key and at least one authentication image of said visitor, said recognition module authenticating that said visitor is said user if said first measure of similarity is greater than a first predetermined threshold, and refining said key with said at least one authentication image of said visitor if said first measure of similarity is lower than said first predetermined threshold and said visitor is authenticated as said user based on a password.

2. The computer-readable medium of claim 1, wherein said recognition module authenticates said visitor based on said password if said first measure of similarity is lower than said first predetermined threshold and greater than a second predetermined threshold.

3. The computer-readable medium of claim 2, wherein said recognition module authenticates that said visitor is not said user if said first measure of similarity is lower than said second predetermined threshold.

4. The computer-readable medium of claim 1 wherein said computer-executable modules further comprise:
a controller operable for controlling said register module and said recognition module in response to a plurality of input commands.

5. The computer-readable medium of claim 1 wherein said computer-executable modules further comprise:
a photography module operable for capturing said at least one first image and said at least one second image of said user, and said at least one authentication image of said visitor.

6. The computer-readable medium of claim 1 wherein said computer-executable modules further comprise:
a database operable for storing said key and for providing said key to said recognition module.

7. The computer-readable medium of claim 1, wherein said register module verifies said key by calculating a second measure of similarity between said key and said at least one second image of said user, and creates a new key for said user according to at least one new image of said user if said second measure of similarity is less than a predetermined threshold.

8. The computer-readable medium of claim 1 wherein said computer-executable modules further comprise:
a cop module operable for sending at least one image of said visitor to a predetermined address if said recognition module authenticates that said visitor is not said user.

9. The computer-readable medium of claim 8 wherein said computer-executable modules further comprise:
a setting module operable for setting and resetting said predetermined address in response to an input command.

10. The computer-readable medium of claim 8 wherein said computer-executable modules further comprise:
a setting module operable for enabling and disabling said cop module in response to an input command.

11. The computer-readable medium of claim 8, wherein said cop module sends an email with said at least one image of said visitor to a predetermined email address via an email server.

12. A computer system comprising:
a processor; and
memory coupled to said processor and having stored therein instructions that, if executed by said computer system, cause the computer system to execute a method for controlling access to a system, said method comprising:
creating a key of a user according to at least one first image of said user captured currently;
verifying said key with at least one second image of said user captured after creating said key;
authenticating a visitor according to a first measure of similarity between said key and at least one authentication image of said visitor;
allowing said visitor to access said system if said first measure of similarity is greater than a first predetermined threshold; and
refining said key with said at least one authentication image of said visitor if said first measure of similarity is lower than said first predetermined threshold and said visitor is authenticated as said user based on a password.

13. The computer system of claim 12, wherein said method further comprises:
authenticating said visitor based on said password if said first measure of similarity is lower than said first predetermined threshold and greater than a second predetermined threshold.

14. The computer system of claim 13, wherein said method further comprises:
preventing said visitor from accessing said system if said first measure of similarity is lower than said second predetermined threshold.

15. The computer system of claim 12, wherein said method further comprises:
capturing said at least one first image and said at least one second image of said user, and said at least one authentication image of said visitor using a photography module.

16. The computer system of claim 12, wherein said method further comprises:
storing said key into a database; and
fetching said key from said database.

17. The computer system of claim 12, wherein said method further comprises:
verifying said key by calculating a second measure of similarity between said key and said at least one second image of said user; and
creating a new key for said user according to at least one new image of said user if said second measure of similarity is less than a predetermined threshold.

18. The computer system of claim 12, wherein said method further comprises:
sending at least one image of said visitor to a predetermined address if said recognition module authenticates that said visitor is not said user.

19. The computer system of claim 18, wherein said method further comprises:
setting and resetting said predetermined address in response to an input command.

20. The computer system of claim 18, wherein said method further comprises:
enabling and disabling said step of sending said at least one image of said visitor to said predetermined address in response to an input command.

21. A computer-readable medium having computer-executable modules comprising:
a recognition module operable for authenticating whether a visitor has authority to access a system, allowing said visitor to access said system if said visitor is authorized, and preventing said visitor from accessing said system if said visitor is unauthorized; and
a cop module operable for sending at least one image of said visitor to a predetermined address if said visitor is unauthorized.

22. The computer-readable medium of claim 21 wherein said computer-executable modules further comprise:
a photography module operable for capturing said at least one image of said visitor.

23. The computer-readable medium of claim 21 wherein said computer-executable modules further comprise:
a setting module operable for setting and resetting said predetermined address in response to an input command.

24. The computer-readable medium of claim 21 wherein said computer-executable modules further comprise:
a setting module operable for enabling and disabling said cop module in response to an input command.

25. The computer-readable medium of claim 21, wherein said cop module sends an email with said at least one image of said visitor to a predetermined email address via an email server.
